(19) United States
(12) Patent Application Publication
(10) Pub. No.: US 2012/0235535 A1
(43) Pub. Date: Sep. 20, 2012

(54) ROTARY ELECTRIC MACHINE

(75) Inventors: Takeshi Watanabe, Tokyo (JP); Makoto Saito, Tokyo (JP)

(73) Assignee: FUJI JUKOGYO KABUSHIKI KAISHA, Tokyo (JP)

(21) Appl. No.: 13/411,879

(22) Filed: Mar. 5, 2012

(30) Foreign Application Priority Data
Mar. 18, 2011 (JP) 2011-059994

(51) Int. Cl. H02K 1/16

(52) U.S. Cl. 310/216.018

(57) ABSTRACT

There is provided a rotary electric machine. A stator is formed by laminating first steel plates and second steel plates, which are formed from an identical magnetic material and having an identical planar shape but different thickness dimensions. Hence, in contrast to a motor/generator (a comparative example) including a stator formed by laminating steel plates having an identical thickness dimension, with which a single resonance frequency is generated (such that a peak value is large), two resonance frequencies are generated, and therefore the peak value can be dispersed between the respective resonance frequencies (such that the peak value is small).

### CROSS-REFERENCE TO RELATED APPLICATIONS

The present application claims priority from Japanese Patent Application No. 2011-059994 filed on Mar. 18, 2011, the entire contents of which are hereby incorporated by reference.

### BACKGROUND OF THE INVENTION

1. Field of the invention

The present invention relates to a rotary electric machine including a motor core formed by laminating a plurality of steel plates.

2. Description of the Related Art

Electric vehicles and hybrid electric vehicles provide a motor/generator as a drive source. The motor/generator is, in many cases, a rotary electric machine including a motor core which is formed by laminating a plurality of steel sheets. The motor/generator is power-driven by a drive current from a high voltage battery such as a lithium ion secondary battery installed in the vehicle. Further, the motor/generator is regeneratively driven when the vehicle decelerates and so on, whereby the high voltage battery is charged.

The motor/generator includes a stator and a rotor as the motor core. The stator is fixed to a housing such as a motor case, and the rotor is provided on an inner side of the stator in the radial direction thereof to be free to rotate via a predetermined gap. The stator and the rotor are both often formed by laminating a plurality of steel plates, and in so doing, the stator and rotor can be manufactured inexpensively while suppressing the generation of eddy currents. A technique described in Japanese Unexamined Patent Application Publication (JP-A) No. S60-022447 (FIG. 2) is available as an example of this type of component including a motor core formed by laminating a plurality of steel plates.

The technique of JP-A. No. S60-022417 refers to a stator (an iron core of an electrical apparatus) formed by laminating a plurality of steel plates is described. With the stator described in JP-A No. S60-022447, when a rotor is driven to rotate, each of the steel plates forming the stator receives a rotary force (torque), and therefore each of the steel plates may shift, deform, and so on as the rotor rotates. For example, FIGS. 10A and 10B are analysis diagrams showing deformation of a stator. As shown by shaded arrows in the drawings, it has been discovered that as the rotor (not shown) rotates, a stator ST deforms in a longitudinal direction and a latitudinal direction.

Hence, a technique described in JP-A No. 2010-057221 (FIG. 1), for example, is available as a technique for solving the problem described above by securing strength in a stator having a laminated structure. In the technique described in JP-A No. 2010-057221, electromagnetic steel plates and cold rolled steel plates having different surface roughness values are laminated alternately. In so doing, the strength of the stator (laminated iron core) is increased so that the steel plates do not shift, deform, and so on as the rotor rotates.

Vibration (motor operation vibration) occurring when the rotor is driven to rotate, for example, may be cited as one of the causes of problems such as shifting of the steel plates. Therefore, by minimizing motor operation vibration, problems such as shifting of the steel plates can be suppressed. Hence, a technique described in JP-A No. 2000-224786 (FIGS. 3 and 5), for example, is available as a technique for reducing motor operation vibration. In the technique described in JP-A. No. 2000-224786, a rotor (a laminated core) formed by laminating a plurality of steel plates is provided, and motor operation vibration is reduced by modifying the shape of the steel, plates forming the rotor.

However, in a motor core described in JP-A No. 2010-057221, electromagnetic steel plates and cold rolled steel plates having different surface roughness values are laminated, and therefore individual manufacturing lines are required to manufacture the respective steel plates. Due to this and other problems, there is a limit to the extent to which the cost of the rotary electric machine can be reduced. Further, in a motor core described in JP-A No. 2000-224786, if the specifications of the rotary electric machine are modified, for example by replacing silicon steel plates with steel plates of another material or increasing the size of the rotary electric machine, a resonance characteristic and so on of the steel plates must be reconsidered based on the modified specifications, leading to a possible reduction in yield.

### SUMMARY OF THE INVENTION

An object of the present invention is to provide a rotary electric machine with which a further cost reduction can be realized in a rotary electric machine exhibiting little vibration and modifications in the specifications of the rotary electric machine can be reflected easily.

An aspect of a rotary electric machine provides a rotary electric machine having a motor core formed by laminating a plurality of steel plates. The motor core is, formed by laminating at least two types of steel plates formed from an identical magnetic material and having an identical planar shape but different thickness dimensions.

According to another aspect the present invention, when the steel plates having different thickness dimensions are defined as a steel plate a to a steel plate n, the steel plates are laminated in a regular arrangement such as a, b to n, a, b to n, a, b to n.

According to further another aspect of the present invention, when the steel plates having different thickness dimensions are defined as a steel plate a to a steel plate n, the steel plates are laminated in an irregular arrangement such as b, c, a, a, b, a, c, b, b, c to n.

With the rotary electric machine according to the present invention, the motor core is formed by laminating at least two types of steel plates formed from an identical magnetic material and having an identical planar shape but different thickness dimensions. Hence, in contrast to a rotary electric machine including a motor core formed by laminating steel plates having an identical thickness dimension, with which a single resonance frequency is generated (such that a peak value is large), at least two resonance frequencies are generated, and therefore the peak value can be dispersed among the respective resonance frequencies (such that the peak value is small). As a result, vibration occurring when the rotary electric machine is driven to rotate can be reduced, whereby operation noise can be reduced and problems such as deformation of the motor core can be suppressed. Only the thickness dimensions of the respective steel plates are differentiated, and it is therefore possible to easily reflect modifications to the specifications of the rotary electric machine, regardless of the material, size, and so on of the steel plates. Furthermore, the respective steel plates can be manufactured easily using an identical manufacturing line, enabling an improvement in yield and a further reduction in the manufacturing cost of the rotary electric machine.

In the rotary electric machine according to the present invention, the respective steel plates having different thickness dimensions, when set as a steel plate a to a steel plate n, may be laminated in either a regular arrangement such as a, b to n, a, b to n, a, b to n or an irregular arrangement such as b, c, a, a, b, a, c, b, b, c to n in order to reduce vibration occurring when the rotary electric machine is driven to rotate.

### BRIEF DESCRIPTION OF THE DRAWINGS

FIG. 1 is a block diagram showing an outline of a driving system for a hybrid vehicle;

FIG. 2 is a sectional view illustrating in detail a structure of a motor/generator according to a first embodiment;

FIG. 3 is a perspective view showing an outline of a motor core forming the motor/generator of FIG. 2;

FIG. 4 is a perspective view showing steel plates of a stator shown in FIG. 3 arranged in exploded form;

FIG. 5 is a graph showing generation of a resonance frequency in the stator of FIG. 3;

FIG. 6 is a perspective view showing steel plates of a stator provided in a motor/generator according to a second embodiment, arranged in exploded form;

FIG. 7 is a graph showing generation of the resonance frequency in the stator of FIG. 6;

FIGS. 8A and 8B are perspective views showing steel plates of rotors according to a third embodiment and a fourth embodiment, arranged in exploded form;

FIG. 9 is a plan view showing a steel plate of a stator provided in a motor/generator according to a fifth embodiment; and

FIGS. 10A and 10B are analysis diagrams showing deformation of a stator.

### DESCRIPTION OF THE PREFERRED EMBODIMENTS

A first embodiment of the present invention will be described in detail below using the drawings.

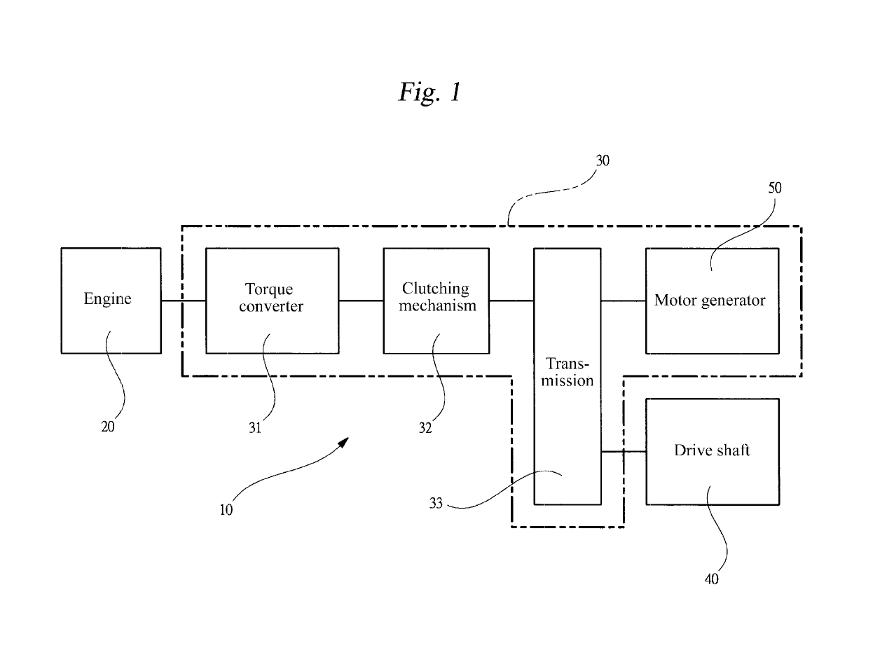

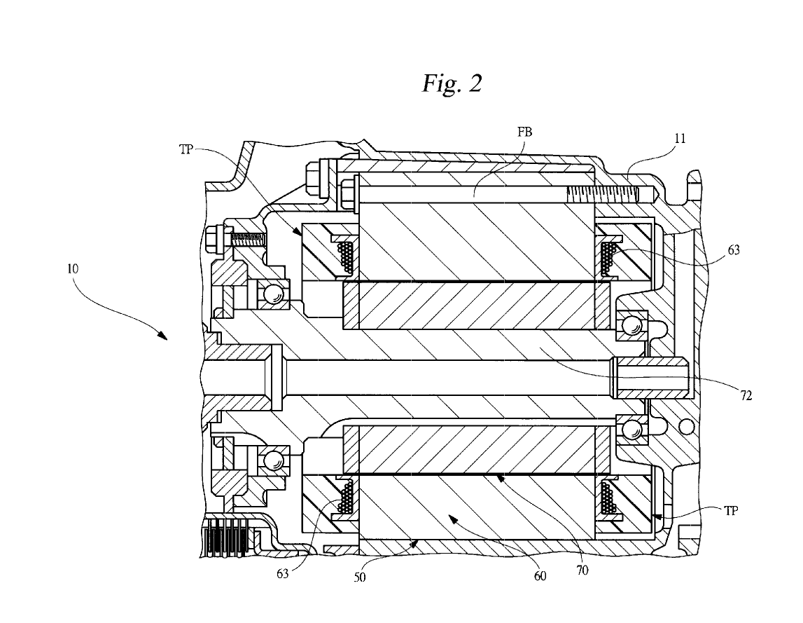

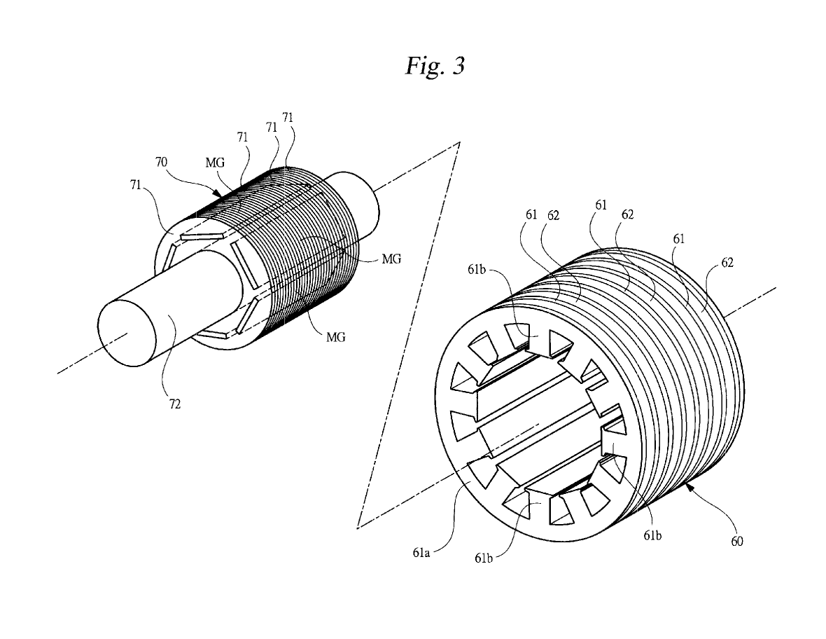

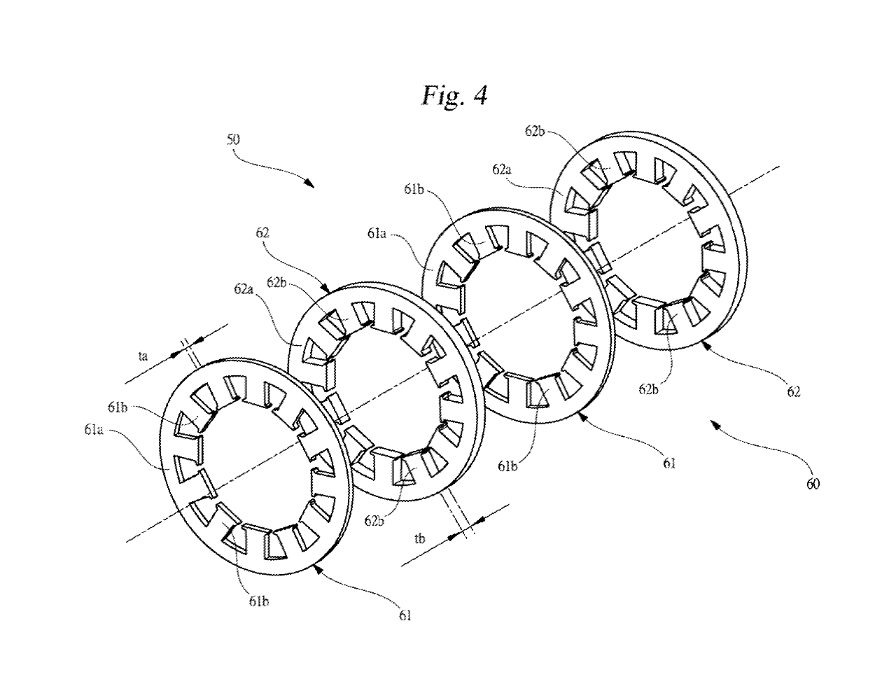

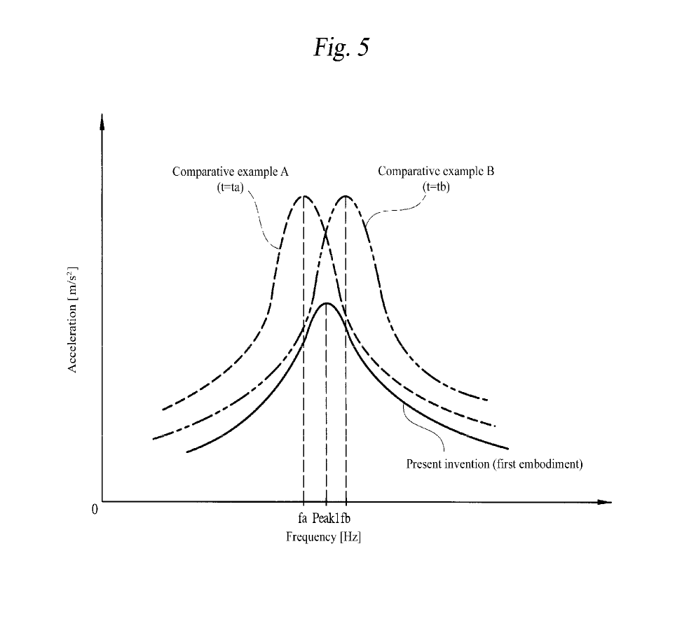

FIG. 1 is a block diagram showing an outline of a driving system for a hybrid vehicle. FIG. 2 is a sectional view illustrating in detail a structure of a motor/generator according to the first embodiment. FIG. 3 is a perspective view showing an outline of a motor core forming the motor/generator of FIG. 2. FIG. 4 is a perspective view showing steel plates of a stator shown in FIG. 3 arranged in exploded form. FIG. 5 is a graph showing generation of a resonance frequency in the stator of FIG. 3.

A hybrid driving apparatus 10 shown in FIG. 1 is installed on a front side of an unillustrated hybrid vehicle (a vehicle) and includes an engine (an internal combustion engine) 20 and a driving mechanism 30 in order to drive a drive shaft 40 to rotate. The driving mechanism 30 is disposed between she engine 20 and the drive shaft. 40 to be capable of transmitting power, and includes a torque converter 31, a clutch mechanism 32, a transmission 33, and a motor/generator (a rotary electric machine) 50.

The torque converter 31 is disposed the engine 20 and the clutch mechanism 32 in order to transmit a power of the engine 20 to the clutch mechanism 32 using unillustrated oil having a comparatively which is charged into the torque converter 31, as an operating medium.

The clutch mechanism 32 is disposed between the torque converter 31 and the transmission 33 in order to engage a power transmission path between the torque converter 31 and the transmission 33 through normal rotation or reverse rotation. More specifically, when a shift position is set to forward (D), the power transmission path is engaged through normal rotation, and when the shift position is set to reverse (R), the power transmission path is engaged through reverse rotation. The clutch mechanism 32 also disengages the power transmission path between the torque converter 31 and the transmission 33: by setting the shift position to neutral (N), the power transmission path is disengaged.

The transmission 33 is disposed between the clutch mechanism 32 and the motor/generator 50 in order to shift a rotation speed (the power) of the engine 20 transmitted thereto via the torque converter 31 and the clutch mechanism 32. The transmission 33 is formed with a continuously variable transmission including an unillustrated primary pulley and an unillustrated secondary pulley, for example. The primary pulley serves as an input side while the secondary pulley serves as an output side. The clutch mechanism 32 and the motor/generator 50 are disposed on the primary pulley side while the drive shaft 40 is disposed on the secondary pulley side. As a result, a rotation speed of the secondary pulley is adjusted continuously, whereby a rotation speed of the drive shaft 40 is adjusted continuously.

Here, the motor/generator 30 functions as a drive motor and a power generator. For example, when the hybrid vehicle is accelerated from a stationary condition, the motor/generator 50 is power-driven such that a large driving torque is generated, enabling smooth acceleration. When the hybrid vehicle cruises at a high speed, on the other hand, a driving condition exhibiting favorable fuel efficiency is established using the power of the engine 20 alone. Further, when the hybrid vehicle is decelerated to a stationary condition, the motor/generator 50 is regeneratively driven, whereby deceleration is achieved while converting kinetic energy into electric energy. The converted electric energy is re covered by being charged to an unillustrated in-vehicle battery.

As shown in FIG. 2, the motor/generator 50 is disposed in a casing 11 that forms an outer shell of the hybrid driving apparatus 10. The casing 11 is formed in a predetermined shape by casting a molten aluminum material or the like, and exhibits a superior heat radiation property. FIG. 2 shows a part (the motor/generator 50 part) of the hybrid driving apparatus 10, in which the engine 20 (see FIG. 1) is disposed on a front side of the motor/generator 50 and the drive shaft 40 (see FIG. 1) is disposed on a lower side of the motor/generator 50. The hybrid driving apparatus 10 is attached to an unillustrated bracket provided on a vehicle body of the hybrid vehicle via an unillustrated mounting bush made of reinforced rubber or the like.

The motor/generator 50 includes a stator 60 serving as a stationary element and a rotor 70 serving as a rotary element. As shown in FIG. 3, the stator 60 and the rotor 70 are each formed by laminating steel plates, and together constitute a motor core according to the present invention.

As shown in FIGS. 3 and 4, the stator 60 includes a plurality of first steel plates 61 and a plurality of second steel plates 62. The steel plates 61 and 62 are each formed in a substantially circular plate shape from an identical magnetic material, for example silicon steel plates or the like. Further, the steel plates 61 and 62 are formed with an identical planar shape when the stator 60 formed by laminating the steel plates 61 and 62 is seen from an axial direction. A thickness dimension of the first steel plate 61 is set to ta, and a thickness dimension of the second steel plate 62 is set to tb, which is thicker than the thickness dimension ta of the first steel plate 61 (ta<tb)

Hence, the steel plates 61 and 62 differ only in the thickness dimension, and are laminated alternately, one at a time, in a regular arrangement such as the steel plate 61, the steel plate 62, the steel plate 61, the steel plate 62, the steel plate 61, . . . , for example. Since the steel plates 61 and 62 differ only in the thickness dimension, they may be molded using an identical pressing machine or the like, for example, enabling an improvement in a manufacturing efficiency of the steel plates 61 and 62. Further, the steel plates 61 and 62 are adhered to each other firmly using an unillustrated adhesive constituted by an insulating material.

The steel plates 61 and 62 respectively include a ring-shaped main body portion 61a and 62a and a plurality of tooth portions 61b and 62b provided integrally with the ring-shaped main body portion 61a and 62a to project to a radial direction inner side. As shown in FIG. 2, the stator 60 (the motor/generator 50) constituted by the steel plates 61 and 62 is fixed inside the casing 11 by screwing a fixing bolt FB to the casing 11.

A coil 63 (see FIG. 2) made of highly conductive copper wire or the like is wound around the tooth portions 61b and 62b of the steel plates 61 and 62 by concentrated winding or distributed winding. The coil 63 is bent back on both axial direction sides of the stator 60, and respective bent back portions TP of she coil 63 are molded using a plastic material or the like serving as an insulating material. As a result, short circuits do not occur between adjacent coils 63 wound around the respective tooth portions 61b and 62b.

As shown in FIGS. 2 and 3, the rotor 70, similarly to the stator 60, is formed by laminating a plurality of ring-shaped steel plates 71 constituted by a magnetic material such as silicon steel plates, and disposed on the radial direction inner side of the stator 60 to be free to rotate via a predetermined gap. The ring-shaped steel plates 71 are likewise adhered to each other firmly using an unillustrated adhesive constituted by an insulating material.

A rotary shaft 72 is inserted fixedly into a central part of the respective ring-shaped steel plates 71, and a plurality of rod-shaped permanent magnets MG are provided on a periphery of the rotary shaft 72 inside the ring-shaped steel plates 71 to extend in an axial direction of the rotary shaft 72. Thus, when a driving current is supplied to the coil 63 (i.e. when the coil 63 is energized), an electromagnetic force is generated, and in accordance with this electromagnetic force, the rotor 70 rotates relative to the stator 60.

A lamination structure of the ring-shaped steel plates 71 forming the rotor 70 differs from that of the steel plates 61 and 62 forming the stator 60 in that the ring-shaped steel plates 71 are formed from an identical magnetic material and set with an identical planar shape and an identical thickness dimension. As a result, an improvement can be realized in the ease with which the rotor 70 is assembled.

Next, an operation of the motor/generator 50 according to the first embodiment having the above formation will be described in detail using the drawings.

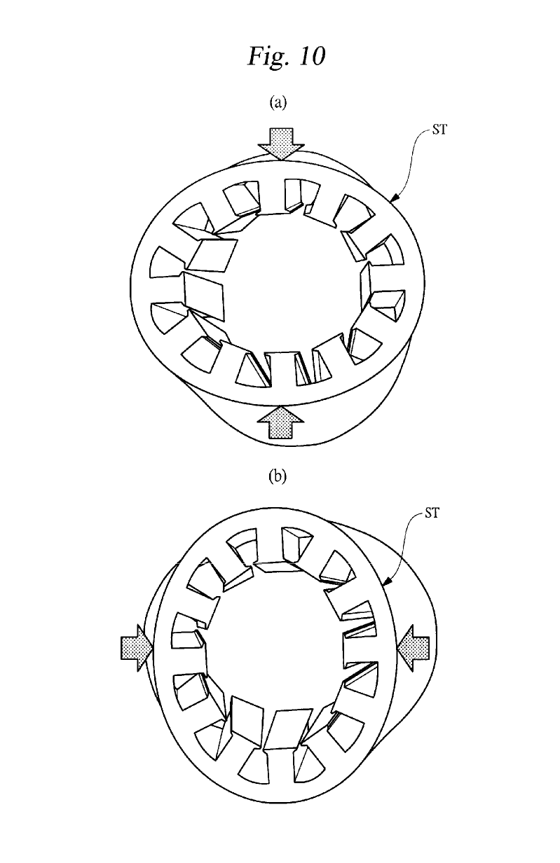

When a driving current is passed through the coil 63, an electromagnetic force is generated in the coil 63. As a result, the motor/generator 50 is driven to rotate such that the rotor 70 rotates relative to the stator 60. At this time, an attraction force that draws the rotor 70 in a rotation direction is generated in the stator 60, causing the rotor 70 to rotate. As shown by shaded arrows in FIG. 10, this attraction force acts to deform the stator 60 in an up-down direction, a left-right direction, and so on. In this embodiment, however, the steel plates 61 and 62 forming the stator 60 are formed with different thickness dimensions and fixed to each other firmly using an adhesive. Therefore, a rigidity of the stator 60 can be increased in comparison with a stator formed by laminating only the thinner first steel plates 61.

Further, after analyzing vibration (motor operation vibration) occurring when the motor/generator 50 is driven to rotate, results shown on a graph (a frequency [Hz]−acceleration [m/s²] graph) in FIG. 5 were obtained. In the motor/generator 50 (the present invention), the first steel plates 61 having the thickness dimension ta and the second steel plates 62 having the thickness dimension tb are laminated alternately. Therefore, a peak value (Peak 1) of a resonance frequency is lower than a peak value (fa) of the resonance frequency exhibited by a comparative example A (t=ta) having a stator formed by laminating only the first steel plate 61 and a peak value (fb) of the resonance frequency of a comparative example B (t=tb) having a stator formed by laminating only the second steel plate 62.

This is because when the steel plates 61 and 62 are laminated alternately, two resonance frequencies are generated in accordance with the two types of steel plates 61 and 62, and therefore the peak value is dispersed between the respective resonance frequencies. Hence, in the motor/generator 50, vibration (motor operation vibration) occurring when the motor/generator 50 is driven to rotate can be suppressed in comparison with the comparative examples A and B having stators formed by laminating a single type of steel plate.

As described in detail above, in the motor/generator 50 according to the first embodiment, the stator 60 is formed by laminating the first steel plates 61 and the second steel plates 62 formed from an identical magnetic material, and having an identical planar shape but different thickness dimensions. Hence, in contrast to a motor/generator (the comparative example A and the comparative example B) including a stator formed by laminating steel plates having an identical thickness dimension, with which a single resonance frequency is generated (such that the teak value is large), two resonance frequencies are generated, and therefore the peak value can be dispersed between the respective resonance frequencies (such that the peak value is small).

As a result, vibration generated when the motor/generator 50 is driven to rotate can be reduced, and therefore operation noise can be reduced and problems such as deformation of the stator 60 can be suppressed. Only the thickness dimensions of the respective steel plates are differentiated, and it is therefore possible to reflect modifications to the specifications of the motor/generator easily, regardless of the material, size, and so on of the steel plates. Furthermore, the steel plates 61 and 62 can be manufactured easily using an identical manufacturing line, enabling an improvement in yield and a further reduction in the manufacturing cost of the motor/generator 50.

Moreover, the first steel plates 61 and the second steel plates 62 are formed from an identical magnetic material in an identical planar shape, and therefore an analysis operation (analysis processing) can be performed easily with respect to vibration occurring when the motor/generator is driven to rotate. As a result, an improvement can be achieved in a design efficiency of the motor/generator.

Next, a second embodiment of the present invention will be described in detail using the drawings. Note that only parts that differ from the first embodiment will be described.

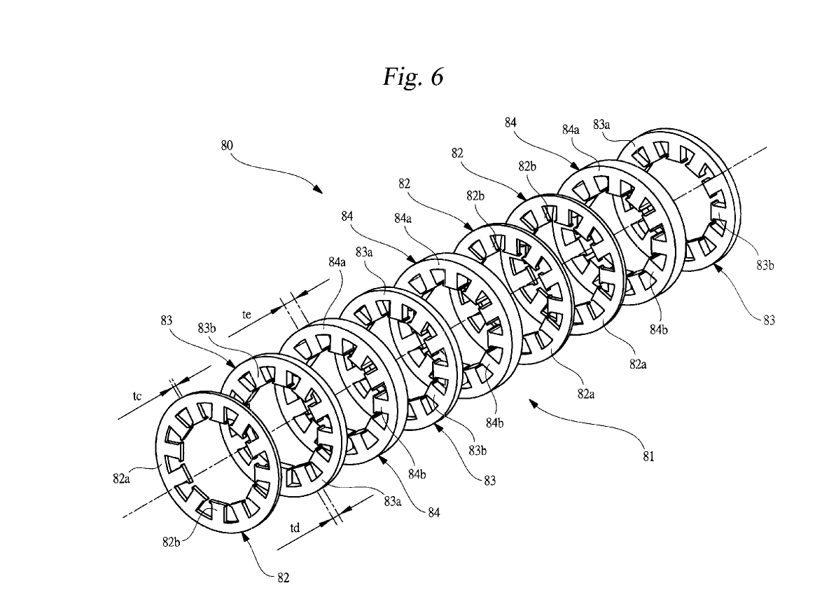

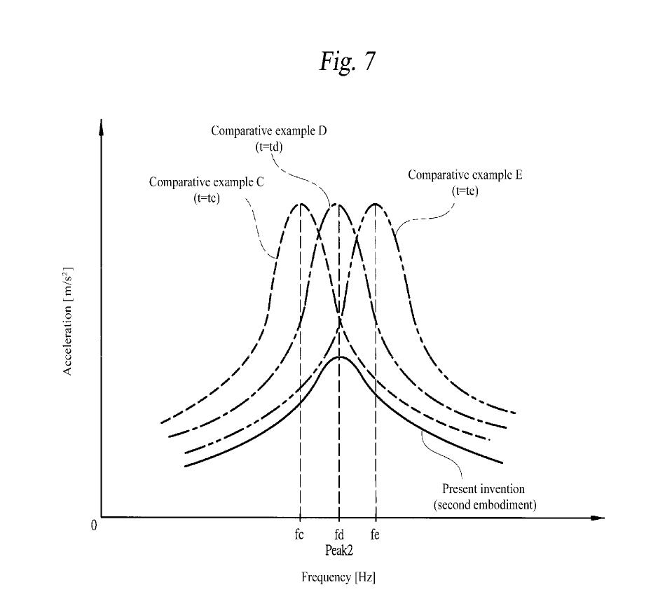

FIG. 6 is a perspective view showing steel plates of a stator provided in a motor/generator according to the second embodiment, arranged in exploded form, and FIG. 7 is a graph showing generation of the resonance frequency in the stator of FIG. 6.

A motor/generator (a rotary electric machine) 80 according to the second embodiment differs from that of the first embodiment only in the lamination structure of the steel plates forming the stator.

As shown in FIG. 6, a stator 81 forming the motor/generator 80 according to the second embodiment includes a plurality of first steel plates 82, a plurality of second steel plates 83, and a plurality of third steel plates 84. The steel plates 82 to 84 are each formed in a substantially circular plate shape from an identical magnetic material, for example silicon steel plates or the like. Further, the steel plates 82 to 84 are formed with an identical planar shape when the stator 81 formed by laminating the steel plates 82 to 84 is seen from the axial direction. A thickness dimension of the first steel plate 82 is set to tc, a thickness dimension of the second steel plate 83 is set to td, and a thickness dimension of the third steel plate 84 is set to te. A magnitude relationship thereof is set as tc<td<te.

Hence, the steel plates 82 to 84 differ only in the thickness dimension, and as shown in FIG. 6, are laminated randomly, one at a time, in an irregular arrangement such as the steel plate 82, the steel plate 83, the steel plate 81, the steel plate 83, the steel plate 84, the steel plate 82, the steel plate 82, the steel plate 84, the steel plate 83, . . . , for example. Note that the steel plates 82 to 81, similarly to the steel plates of the first embodiment, respectively include a ring-shaped main body portion 82a to 84a and a plurality of tooth portions 82b to 84b.

After analyzing vibration (motor operation vibration) generated by the stator 81, results shown on a graph (a frequency [Hz]−acceleration [m/s²] graph) in FIG. 7 were obtained. In the second embodiment, the first steel plates 82 having the thickness dimension tc, the second steel plates 83 having the thickness dimension td, and the third steel plates 84 having the thickness dimension te are laminated randomly. Therefore, a peak value (Peak 2) of the resonance frequency is lower than a peak value (fc) of the resonance frequency exhibited by a comparative example C (t=tc) having a stator formed by laminating only the first steel plate 82, a peak value (fd) of the resonance frequency of a comparative example C (t=td) having a stator formed by laminating only the second steel plate 83, and a peak value (fe) of the resonance frequency of a comparative example E (t=te) having a stator formed by laminating only the third steel plate 84.

Here, a reduction width of the peak value (Peak 2) is greater than that of the peak value (Peak 1) obtained in the first embodiment. This is because the number of types of steel plates having different thickness dimensions is increased so that the three types of steel plates 82 to 84 are provided. Note that the steel plates 82 to 84 are preferably provided in equal numbers. In so doing, the peak value can be dispersed among the respective resonance frequencies substantially evenly, whereby the peak value (Peak 2) can be reduced effectively.

However, the number of laminated types of steel plates is not limited to three, and two, four, or more types of steel plates may be laminated randomly. Note that when two types of steel plates are laminated irregularly (randomly), a steel plate (1) and a steel plate (2) are laminated in an irregular arrangement such as the steel plate (1), the steel plate (2), the steel plate (2), the steel plate (1), the steel plate (2), the steel plate (2), the steel plate (2), the steel plate (1), the steel plate (2), the steel plate (1), . . . , for example.

As described in detail above, with the motor/generator 80 according to the second embodiment, similar actions and effects to those of the first embodiment are obtained. Additionally, in the second embodiment, the steel plates 82 to 84 are laminated randomly (laminated irregularly), and therefore the steel plates 82 to 84 do not have to be arranged methodically during assembly. Hence, the operation for laminating the steel plates 82 to 84 can be simplified.

Next, third and fourth embodiments of the present invention will be described in detail using the drawings. Note that only parts that differ from the first embodiment will be described.

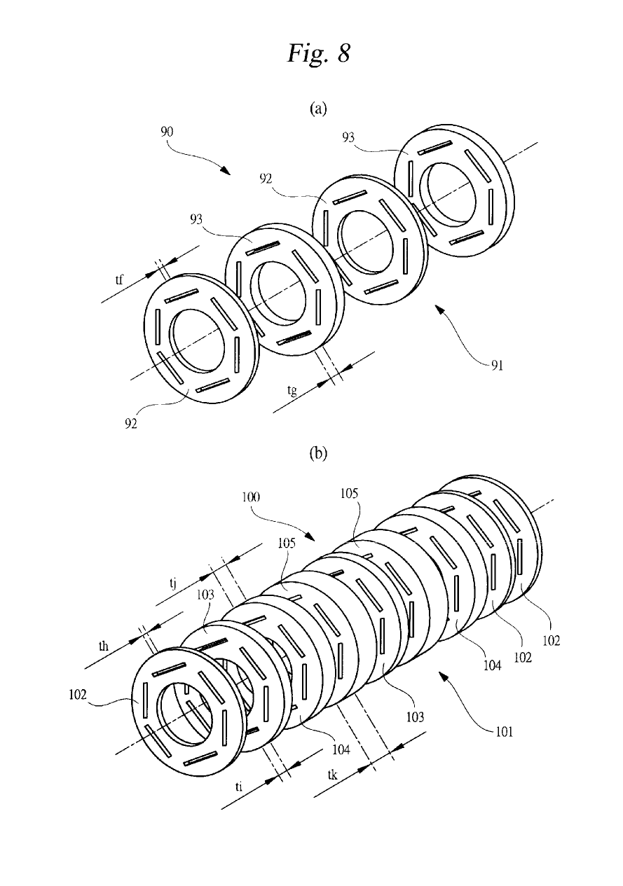

FIGS. 8A and 8B are perspective views showing steel plates of rotors according to the third embodiment and the fourth embodiment, arranged in exploded form.

As shown in FIG. 8A, a motor/generator (a rotary electric machine) 90 according to the third embodiment differs from that of the first embodiment only in the lamination structure of the steel plates forming the rotor.

A rotor 91 forming a motor/generator 90 according to the third embodiment includes first ring-shaped steel plates 92 having a thickness dimension tf and second ring-shaped steel places 93 having a thickness dimension tg (where tf<tg) The ring-shaped steel plates 92 and 93 are laminated alternately, one at a time, in a regular arrangement such as the ring-shaped steel plate 92, the ring-shaped steel plate 93, the ring-shaped steel plate 92, the ring-shaped steel plate 93, the ring-shaped steel plate 92, . . . , for example.

With the motor/generator 90 according to the third embodiment formed as described above, similar actions and effects to those of the first embodiment are obtained. Additionally, in the third embodiment, the rotor 91 is likewise formed by laminating the first ring-shaped steel plates 92 and the second ring-shaped steel plates 93 having different thickness dimensions, and therefore vibration occurring when the motor/generator 90 is driven to rotate can be reduced even further.

As shown in FIG. 8B, a rotor 101 forming a motor/generator (a rotary electric machine) 100 according to the fourth embodiment includes a plurality of first ring-shaped steel plates 102 (thickness dimension th), a plurality of second ring-shaped steel plates 103 (thickness dimension ti), a plurality of third ring-shaped steel plates 104 (thickness dimension tj), and a plurality of fourth ring-shaped steel plates 105 (thickness dimension tk). A relationship between the thickness dimensions of the ring-shaped steel plates 102 to 105 is set as th<ti<tj<tk.

As shown in the drawing, the ring-shaped, steel plates 102 to 105 are laminated randomly, one at a time, in an irregular arrangement such as the ring-shaped steel plate 102, the ring-shaped steel plate 103, the ring-shaped steel plate 104, the ring-shaped steel plate 105, the ring-shaped steel, plate 103, the ring-shaped steel plate 105, the ring-shaped steel plate 104, the ring-shaped steel plate 102, the ring-shaped steel plate 102, . . . , for example.

With the motor/generator 100 according to the fourth embodiment formed as described above, similar actions and effects to those of the third embodiment are obtained. Additionally, in the fourth embodiment, The respective ring-shaped steel plates 102 to 105 are laminated randomly (irregularly), and therefore the ring-shaped steel plates 102 to 105 do not have to be arranged methodically during assembly. Hence, an operation for assembling the rotor 101 can be simplified ed in comparison with the third embodiment.

Note that the steel plates forming the stators of the motor/generators 90 and 100 according to the third and fourth embodiments may be laminated randomly (see FIG. 6 of the second embodiment). In this case, in addition to the effects described above, an improvement, in the ease with which the stator is assembled can be achieved.

Next, a fifth embodiment of the present invention will be described in detail using the drawings. Note that only parts that differ from the first embodiment will be described.

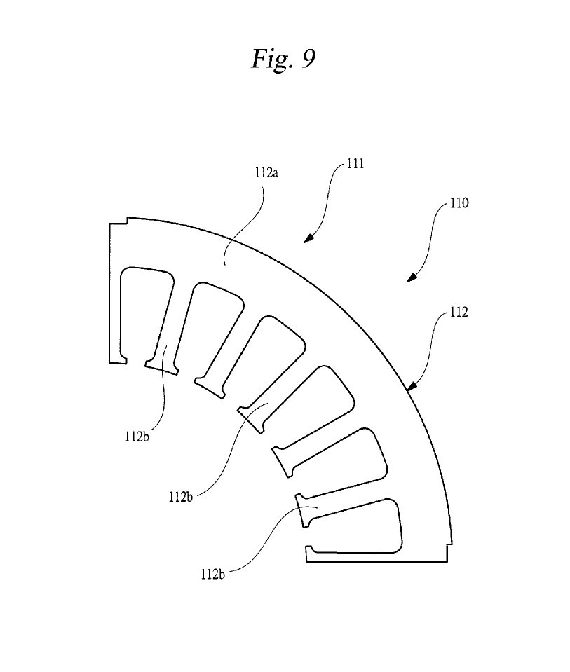

FIG. 9 is a plan view showing a steel plate of a stator provided in a motor/generator according to the fifth embodiment.

As shown in FIG. 9, a stator 111 of a motor/generator (a rotary electric machine) 110 according no the fifth embodiment is formed in a ring shape by assembling divided steel plates 112 (only one of which is shown in the drawing) in a circumferential direction thereof. Using four of the same divided steel plates 112, the stator 111 can be formed in a ring shape similar to that of the steel plates 61 and 62 (see FIG. 4) according to the first embodiment. The divided steel plate 112 likewise includes a main body 112a and a plurality of tooth portions 112b.

With the motor/generator 110 according to the fifth embodiment formed as described above, similar actions and effects to those of the first embodiment are obtained. Additionally, in the fifth embodiment, divided steel plates having different thickness dimensions may be used, and these divided steel plates can be assembled alternately in the circumferential direction thereof. In this case, vibration occurring when the motor/generator is driven to rotate can be suppressed even further.

The present invention is not limited to the embodiments described above and may of course be subjected to various modifications within a scope that does non depart from the spirit thereof. For example, in the above embodiments, the steel plates are laminated one at a time either alternately (regularly) or randomly (irregularly), but the present invention is not limited thereto. Alternatively, for example, sets of five steel plates may be prepared such that the sets of steel plates (steel plate sets) are laminated one set at a time either alternately or randomly.

Further, in the above embodiments, cases in which the present invention is applied to a hybrid vehicle having the engine 20 and the motor/generator 50, 80, 90, 100 and 110 were described, but the present invention is not limited thereto and 110 may also be applied to an electric vehicle (EV) or the like having only a motor/generator as a drive source, for example.

What is claimed is

1. A rotary electric machine having a motor core formed by laminating a plurality of steel plates,
wherein said motor core is formed by laminating at least two types of steel plates formed from an identical magnetic material and having an identical planar shape but different thickness dimensions:

2. The rotary electric machine according to claim 1, wherein, when said steel plates having different thickness dimensions are defined as a steel plate a to a steel plate n, said steel plates are laminated in a regular arrangement such as a, b to n, a, b to n, a, b to n.

3. The rotary electric machine according to claim 1, wherein, when said steel plates having different thickness dimensions are defined as a steel plate a to a steel plate n, said steel plates are laminated in an irregular arrangement such as b, c, a, a, b, a, c, b, b, c to n.
